(19) United States
(12) Patent Application Publication
(10) Pub. No.: US 2006/0071640 A1
(43) Pub. Date: Apr. 6, 2006

(54) Fast-recovery circuitry and method for a capacitor charging power supply

(75) Inventors: Steven C. McCool, Austin, TX (US); Rens Ross, Austin, TX (US); David A. Gwinn, Lowell, MA (US); Steven James Schmidt, Round Rock, TX (US)

Correspondence Address: ROSS SPENCER GARSSON;WINSTEAD SECHREST & MINICK P.C., P. O. BOX 50784, DALLAS, TX, 75201, US

(73) Assignee: Nanotechnologies, Inc., Austin, TX (US)

(21) Appl. No.: 10/955,256

(22) Filed: Sep. 30, 2004

(51) Int. Cl. H02J 7/00

(52) U.S. Cl. 320/116

(57) ABSTRACT

A power supply with a high voltage current regulated output wherein input devices are gated ON and OFF to regulate the output current. The output current is coupled through a current limiting inductor to a high voltage fast electronic switch (E-switch) that turns ON and OFF much faster than the power supply can shut down. The electronic switch is bypassed with a resistor network that is sized to dissipate slightly in excess of the full power rating of the power supply during a shut-down cycle. The electronic switch is normally gated ON providing a low impedance path for current charging the capacitor bank. When a short circuit condition is sensed, the E-switch is turned OFF and the resistor network limits the short circuit current, limits the voltage across the E-switch, and dissipates any energy stored in the inductor and the power supply circuitry during power supply shut-down.

### TECHNICAL FIELD

The present invention relates in general to high voltage and high power capacitive charging supplies with circuitry that allows fast recovery from output short circuit conditions.

### BACKGROUND INFORMATION

To provide a high voltage, high current power supply for pulsed power applications usually entails charging a capacitor with a high voltage power supply over a relatively long time period and discharging the capacitor over a much shorter time period. The simplest circuit would entail a high constant voltage power supply with a current limiting resistor in series with the output. If a short circuit occurred in this power supply, additional circuitry would need to be added to quickly disable the charging path or the current limiting resistor would have to be capable of dissipating power generated by the short circuit current until output of the high voltage power supply is disabled. This design has very poor efficiency and is unacceptable for high power applications where currents may range up to 1000 amperes and voltages may range up to 20,000 volts.

It is typically difficult to protect high power, high-voltage supplies from unexpected short circuits. In pulsed power supplies, a normal delivery of pulsed power is essentially a short circuit condition which would either require turning off the supply before each discharge, or for the protection circuitry to be activated frequently. The current in such pulsed power discharges can rise in less than one millisecond (sometimes substantially less) and the protection circuit must respond on this timescale to avoid damage to the power supply. Unfortunately, in some applications, including pulsed arc processes, such unexpected short circuits are unavoidable and occur frequently. Power supplies for these applications may be protected with fast acting fuses or circuit breakers. However, fuses, circuit breakers, and most other short circuit protection circuitry for high voltage power supplies have a relatively slow response and are not designed for either frequent short circuits during a high power output condition or for rapid recovery from such an event. For a manufacturing process employing pulsed power, present designs experience an unacceptable loss of operating duty cycle when subjected to frequent unexpected output short circuits.

Another shortcoming of most presently available high-power capacitive charging supplies is an inability to tolerate a polarity reversing (ringing) discharge while charging. Frequently, relatively low power diodes in the power supply output are destroyed during voltage reversal when subjected to the full pulsed power current which can be in the range of 10's to 100's of kilo-amperes.

There is, therefore, a need for a robust, high efficiency, fast response, fast recovery short circuit protection circuit for a pulsed power supply that experiences frequent short circuits during high power output conditions. There is also a need for such a circuit where ringing capacitive discharges may occur or where high charging duty cycle is required as in a manufacturing application.

### SUMMARY OF THE INVENTION

A high voltage power supply is used for charging a capacitor bank which is then discharged over a short period to provide high pulsed power (energy/unit time). The high voltage power supply is coupled to the capacitor bank with a high current series inductor and a high speed, high voltage electronic switch. The inductor is used to limit the current rise time when the capacitor bank is fully discharged or the high voltage electronic switch is closed and the output is experiencing a short circuit condition. The charging power supply is current regulated with a feedback control circuit in normal operation. A current sensor generates a measure of the output current which is then fed back to a current regulator circuit. In one embodiment, the current regulator controls a phase angle firing circuit for silicon controlled rectifiers (SCRs) controlling the input windings of a 3-phase 50/60 Hz transformer. If the current exceeds a desired value, the SCRs on the 3-phases are fired later in the voltage cycle to limit the amount of current provided by a given winding. If the output current continues to rise, the SCR firing may be disabled and as each SCR transitions through zero current they turn OFF. When all the SCRs are disabled, the primary windings are opened using low speed electro-mechanical switching.

The high speed electronic switch may also be controlled by a measure of the output current and a measure of the output voltage on the load side of the switch. The high speed electronic switch is bypassed by a resistance network that is configured to dissipate slightly in excess of full power for the time period required for all of the power supply's SCRs to shut down. If the output current is greater than a predetermined value, such as will occur in a short-circuit condition, the control circuit detects the condition. The electronic switch is turned OFF and the full load power is dissipated by the bypass resistance network which limits the short circuit current and the voltage across the high speed electronic switch during the shut down period. Simultaneously, the SCR current regulator is shut-down preventing an excessive current surge. After a delay time, in the range of 200 milliseconds, the electronic switch may be turned ON again either automatically or by an operator reset. If the short circuit condition has cleared (result of normal discharge) then the charging cycle will begin immediately. If the short circuit has not cleared, then the switch will be turned OFF again. An operator may then be notified of a non-clearing short circuit condition.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a circuit diagram of the power system according to embodiments of the present invention; and

FIG. 2 is a flow diagram of method steps used in embodiments of the present invention.

### DETAILED DESCRIPTION

In the following description, numerous specific details are set forth to provide a thorough understanding of the present invention. However, it will be obvious to those skilled in the art that the present invention may be practiced without such specific details. In other instances, well-known circuits may be shown in block diagram form in order not to obscure the present invention in unnecessary detail. For the most part, details concerning timing, and the like have been omitted inasmuch as such details are not necessary to obtain a complete understanding of the present invention and are within the skills of persons of ordinary skill in the relevant art.

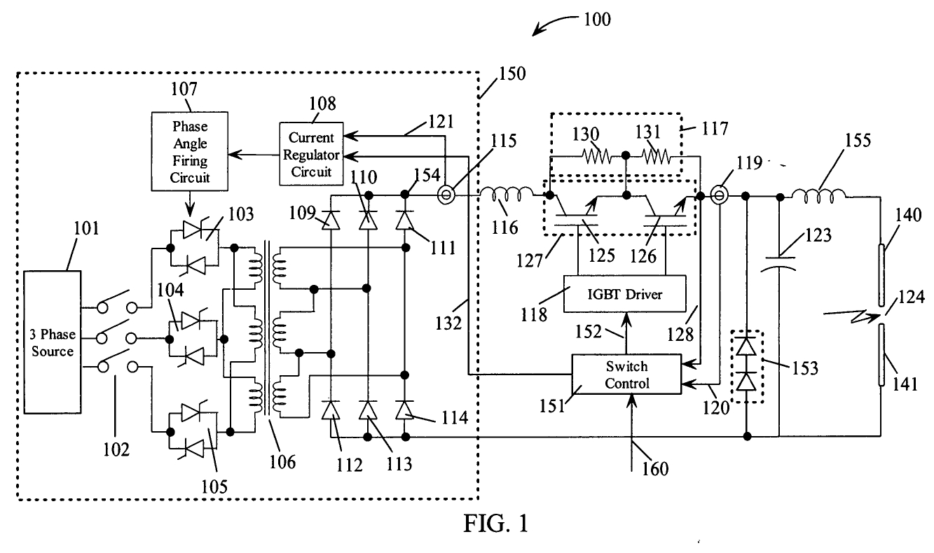

FIG. 1 is a circuit diagram of a capacitor charging power system 100 for an arc discharging process according to embodiments of the present invention. Power system 100 has a power supply section 150 and added circuitry according to embodiments of the present invention to protect the power supply section. Alternative embodiments with other power supply designs for power supply section 150 are considered within the scope of the present invention. Three phase 50/60 Hz power source 101 is coupled to a 3-phase isolation transformer 106 with electro-mechanical switch 102 and back-to-back SCR control devices 103-105. SCRs 103-105 control the period of time the power source 101 is coupled to the primary of isolation transformer 106 as a means of varying the output voltage and thus the output current. Isolation transformer 106 is a step-up transformer providing the high voltage that enables a controlled output current. Phase angle firing circuit 107 is triggered by current regulator circuit 108 in response to a measure of the output current by current transformer 115 which generates a control signal 121. Current sensors other than a current transformer may be used for the power supply 100 current control. Diode rectifiers 109-114 form a full wave 3-phase bridge rectifier that converts the AC output current of transformer 106 to half sine waves with an average DC value. By modulating the voltage at output 154 in response to a measure of the current (as measured by current transformer 115), the current charging capacitor bank 123 may be set to a predetermined value over the charging cycle of capacitor bank 123. If a short circuit condition occurred at output 154, the current would increase to an unsafe value before the SCRs 103-105 could be turned OFF. Inductor 116 is added in series with output 154 to limit the rate of current rise such as those occurring during an output short-circuit.

To further limit the current from output 154, embodiments of the present invention add a high speed, high voltage electronic switch (E-switch) 127 to couple the current from output 154 to capacitor 123. A second current sensor 119 is used to measure the current going to capacitor 123 and to the discharge load comprising electrodes 140 and 141 with an air gap 124. Normally an arc is initiated in gap 124 which creates a “virtual” short circuit condition for the time the arc is maintained. An arc may be initiated either on purpose or spontaneously if the conditions in the gap 124 and the voltage across capacitor 123 are conducive for initiating an arc. In normal operation, before an arc is intentionally initiated, SCR firing is briefly disabled, and E-switch 127 is shut OFF during the discharge.

Whether the arc is initiated intentionally or spontaneously, the arc will normally extinguish (short circuit condition clears) when the energy of capacitor 123 can no longer provide the current necessary to sustain the arc. However, with a spontaneous arc in which E-switch 127 is ON, the current from output 154 would rise to a value which would damage components of power supply section 150. Inductor 155 has a low inductance compared to that of inductor 116 and is used to shape the current rise from capacitor 123, but it does not have enough inductance to protect the power supply. The current from output 154 is typically not adequate to maintain an arc, but during the pulsed discharge, or during other fault conditions, the current from output 154 can increase to an unacceptable high level before current regulator circuit 108 and SCRs 103-105 can remove the voltage from source 101. E-switch 127 can rapidly remove the load coupled to output 128 but the current in inductor 116 would generate a destructive high voltage across E-switch 127. To limit the voltage across E-switch 127 when it is shut OFF, embodiments of the present invention add resistor network 117. Now the voltage across an open E-switch 127 is limited to the current in inductor 116 times the resistance of network 117.

In FIG. 1, two high voltage insulated gate bipolar transistors (IGBT) 125 and 126 are used to make up E-switch 127. IGBT 125 and 126 are controlled by IGBT driver 118 in response to control signal 152. Control signal 152 is generated by switch control 151 in response to output current sense signal 120 and output voltage 128. While current regulator circuit 108 and driver circuit 118 are shown receiving separate measures of the output current from current sensors 115 and 119, it is understood that one sensor could provide a measure of the output current to both control circuits. Various circuits may be employed for IGBT driver 118 that are turned ON and OFF in response to logic states of control signal 152. For example, Applied Power Systems, 124 Charlotte Ave., Hicksville, N.Y. 11801-2620 has an IGBT driver Model #AP-1318 suitable for driving IGBTs 125 and 126.

E-switch 127 is bypassed by resistance network 117 made up of resistors 130 and 131. When E-switch 127 is configured from a plurality of switching devices (e.g., IGBTs 125 and 126), it is desirable to ensure that the high voltage is distributed equally across the devices and to provide a path for interrupted current in current limiting inductor 116 to flow in the event E-switch 127 is turned OFF. Resistors 130 and 131 are sized to dissipate slightly in excess of the entire rated load power during the time required to shut down the power supply section 150 of power system 100 in the event a short circuit condition is detected. Multiple resistors are used to ensure voltage sharing between the required number of IGBTs. As stated earlier, in one embodiment of the present invention, capacitor bank 123 provides pulsed power to electrodes 140 and 141. Capacitor bank 123 starts discharging when an arc between electrodes 140 and 141 (not shown) in gap 124 is initiated. Capacitor bank 123 is normally discharged in response to a control signal; however, discharges may be inadvertently initiated by the proximity of electrodes 140 and 141. When electrodes 140 and 141 arc, a short circuit condition results which will normally clear when the energy on capacitor bank 123 is insufficient to maintain the arc.

Optional very high current diodes 153 may be used to prevent ringing the capacitor bank to a negative polarity. Multiple diodes are shown in series to increase the voltage rating. Such diodes are frequently required with available high voltage power supply designs, but as long as the voltage rating of E-switch 127 is adequate to withstand the charging supply output voltage plus the absolute value of the negative ringing voltage, the protection circuit shown in FIG. 1 will protect the power supply from damage.

A short-circuit or other over-current condition is detected when the output current (sensed by sensor 119) exceeds a predetermined value. Switch control 151 will signal IGBT driver 118 to turn IGBTs 125 and 126 OFF and also signal current regulator 108 with signal 132 to begin a brief shut down of power supply section 150. In the event of an unexpected pulsed discharge (self-clearing short circuit condition), the power supply resets within approximately 200 ms. In the event of a non-clearing short circuit condition, an indication may be sent to an operator of power system 100. During a short circuit condition inductor 116 limits the rise of current at output 154 and high speed E-switch 127 disconnects the load. Resistor network 117 limits the magnitude of a short circuit current and limits the voltage that develops across E-switch 127 when it opens. Resistor network 117 is split into a series of resistors to cause the voltage that develops across open E-switch 127 to distribute equally across the devices (e.g., IGBTs 125 and 126) used to implement E-switch 127. Resistor network 117 dissipates the energy from the secondary of transformer 106 and inductor 116 while the SCRs 103-105 sequentially turn OFF as their corresponding phase currents go through zero after feedback signal 132 signals a short circuit shut-down.

Another embodiment of the invention allows a shut down to be initiated by an external shut down signal 160. Other embodiments may use both voltage 128 and the output current 120, as measured with current sensor 119, to determine when a sustained short circuit condition exists. If the capacitor bank voltage drops unexpectedly, this indicates an un-triggered pulsed discharge is occurring. In this embodiment, there is an option to wait a period of time before starting a shut down of power supply section 150 to determine if the short circuit condition clears. Resistance 117 is sized to handle the full output power of a short circuit for the wait period of time.

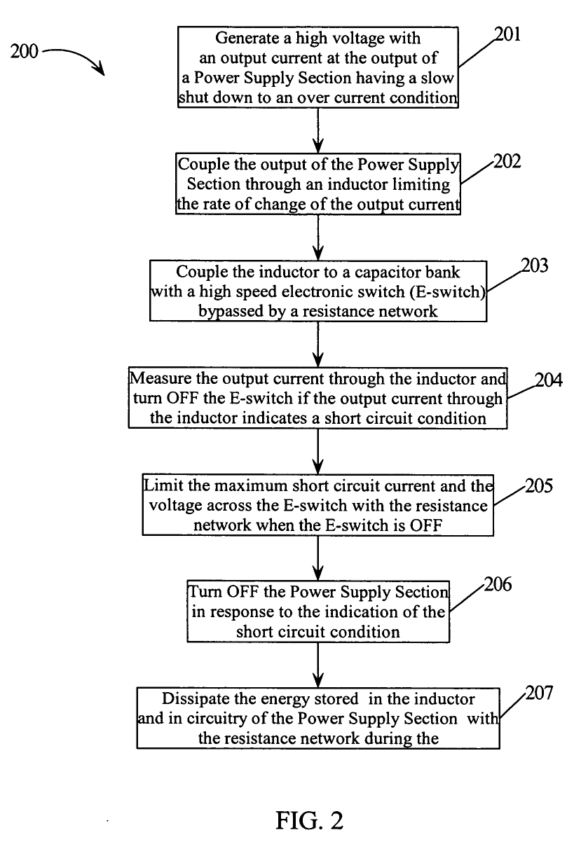

FIG. 2 is a flow diagram of method steps in process 200 for providing charging current to an capacitor bank according to embodiments of the present invention. In step 201, a high voltage is generated in a power supply section that is slow to shut-down in an over current condition. In step 202, the output of the power supply section is coupled to a current rise time limiting inductor that controls the current rise time of the controlled current in a short circuit condition. In step 203, the inductor is coupled to the capacitor bank with a high voltage, high speed, electronic switch (E-switch) that is bypassed with a parallel resistance network. In step 204, the current through the inductor is monitored and the E-switch is turned OFF if the measure of the current through the inductor indicates a short circuit condition. In step 205, the maximum short circuit current and the maximum voltage across the E-switch is limited by the value of the resistance network when the E-switch turns OFF. In step 206, the power supply section is turned OFF in response to the indication of the s short circuit condition. In step 207, the energy stored in the transformer of the power supply section and the inductor are dissipated by the resistance network during the slow shut-down of the power supply section.

Although the present invention and its advantages have been described in detail, it should be understood that various changes, substitutions and alterations can be made herein without departing from the spirit and scope of the invention as defined by the appended claims.

What is claimed is:

1. A method of charging a capacitor bank providing pulsed power to a load coupled across the capacitor comprising the steps of:
generating a controlled current from a high voltage potential of a high voltage power supply in response to a first control signal;
limiting the rate of change of the controlled output current through an inductor, wherein the inductor is coupled to the capacitor bank with a series network of an electronic switch in parallel with a bypass resistance;
providing a low impedance with the electronic switch in response to a first state of the first control signal and a high impedance in response to a second state of the first control signal;
generating the second state of the first control signal when the controlled output current exceeds a predetermined maximum over current value; and
coupling the controlled output current from the inductor through the bypass resistance during the time required to turn OFF the high voltage potential.

2. The method of claim 1, wherein a time required to turn OFF the high voltage potential is too long to limit a maximum value of the controlled output current to below a maximum short circuit value.

3. The method of claim 1, wherein the high voltage power supply modulates the high voltage potential to generate the controlled output current.

4. The method of claim 2, wherein a rate suitable for modulating the high voltage potential to generate the controlled output current is too slow to maintain the controlled output current below the maximum short circuit value during a fault condition.

5. The method of claim 2, wherein the electronic switch comprises a plurality of series coupled insulated gate bipolar transistors (IGBTs) controlled in response to the first control signal.

6. The method of claim 1, wherein the bypass resistance is partitioned such that a substantially equal portions of the bypass resistance are coupled from a collector node to an emitter node of each of the plurality of IGBTs.

7. The method of claim 2, wherein the bypass resistance limits the controlled output current below the maximum short circuit value during the time required to turn OFF the high voltage potential.

8. The method of claim 7, wherein the bypass resistance limits a voltage developed across the electronic switch during the time required to turn OFF the first voltage potential.

9. The method of claim 8, wherein the bypass resistance dissipates any energy stored in the inductor and circuitry of the high voltage power supply during the time required to turn OFF the first voltage potential.

10. The method of claim 9, wherein the bypass resistance is sized to dissipate an energy slightly larger that the output energy of the power supply during the time required to turn OFF the first voltage potential.

11. The method of claim 1, wherein the capacitor is discharged by initiating an arc between a first and second electrode coupled across the capacitor.

12. A power system for charging a capacitor providing pulsed power to a load coupled across the capacitor comprising:
a high voltage power supply having a first voltage potential between a first power supply node and a second power supply node, wherein the first voltage potential provides an output current in response to a first control signal;
an inductor having a first node coupled to the first power supply node and a second node, wherein the inductor limits the rate of change of the output current;
an electronic switch having a first node coupled to the second node of the inductor and a second node coupled to a first node of the capacitor, wherein the electronic switch provides a low impedance to the output current from the inductor in response to a first state of the first control signal and a high impedance to the output current from the inductor in response to a second state of the first control signal;
a bypass resistance coupled across the first and second nodes of the electronic switch, wherein the output current flows primarily through the bypass resistance during the second state of the first control signal; and
a control circuit generating the first control signal in response to a measure of the output current.

13. The power system of claim 12, wherein a time required to turn OFF the first voltage potential is too long to limit a maximum value of the output current to below a maximum short circuit value;

14. The power system of claim 12, wherein the high voltage power supply modulates the first voltage potential to generate the controlled output current.

15. The power system of claim 14, wherein a rate suitable for modulating the first voltage potential to generate the controlled output current is too slow to maintain the controlled output current below the maximum short circuit value during a fault condition.

16. The power system of claim 14, wherein the electronic switch comprises a plurality of series coupled insulated gate bipolar transistors (IGBTs) controlled in response to the first control signal.

17. The power system of claim 16, wherein the bypass resistance is partitioned such that a substantially equal portions of the bypass resistance are coupled from a collector node to an emitter node of each of the plurality of IGBTs.

18. The method of claim 17, wherein the bypass resistance limits the controlled output current below the maximum short circuit value during the time required to turn OFF the first voltage potential.

19. The power system of claim 18, wherein the bypass resistance limits a voltage developed across the electronic switch during the time required to turn OFF the first voltage potential.

20. The power system of claim 19, wherein the bypass resistance dissipates energy stored in the inductor and circuitry of the high voltage power supply during the time required to turn OFF the first voltage potential.

21. The power system of claim 12, wherein the second logic state of the first control signal is generated in response to an external power shut down command.

22. The power system of claim 12, wherein the capacitor is discharged by initiating an arc between a first and second electrode coupled across the capacitor.

23. A method of operating a power system for charging a capacitor providing pulsed power to an initiated arc between a first and second electrode coupled across a first and second node of the capacitor comprising the steps of:
providing high voltage power supply having an output voltage with a controlled current, wherein the high voltage power supply has short circuit protection circuitry with a slow response time;
coupling the output voltage of the high voltage power supply to the capacitor with a fast response switch in parallel with a bypass resistance suitable for dissipating a power corresponding to the product of the output voltage and the controlled current, wherein the fast response switch is gated ON until a sustained short circuit condition is detected;
determining if there is the sustained short circuit condition in response to sensing the current through the fast electronic switch and a voltage across the capacitor;
turning OFF the fast electronic switch, wherein stored energy of the power supply is dissipated in the parallel load resistor protecting the fast electronic switch;
testing whether the sustained short circuit condition has cleared by turning ON the fast electronic switch and repeating the determining step; and
signaling the short circuit protection circuitry in the high voltage power supply with the slow response time to shut down in response to a non-clearing sustained short circuit condition.

24. A power system for charging a capacitor bank with a controlled current comprising:
a high voltage power supply providing a controlled current from a high voltage potential in response to a first control signal;
an inductor coupled in series with the high voltage potential to limit the rate of change of the controlled current;
an electronic switch in series with the inductor that provides a low impedance in response to a first state of the first control signal and a high in response to a second state of the first control signal;
a bypass resistance in parallel with the electronic switch, wherein the output current flows primarily through the bypass resistance during the second state of the first control signal; and
a control circuit generating the first control signal in response to a measure of the controlled current, wherein the bypass resistance limits a magnitude of the controlled current and a voltage potential developed across the electronic switch.
